(19) United States
(12) Patent Application Publication
(10) Pub. No.: US 2025/0245280 A1
(43) Pub. Date: Jul. 31, 2025

(54) AUTOMATED ENHANCEMENT OF USER-GENERATED CONTENT WITH SUPPORTING EVIDENCE

(71) Applicant: INTERNATIONAL BUSINESS MACHINES CORPORATION, ARMONK, NY (US)

(72) Inventors: Tohru Hasegawa, Tokyo (JP); KENTA WATANABE, Soka (JP); Yasumasa Kajinaga, Funabashi (JP); KEISUKE NITTA, Koshigaya (JP); Sayaka Tamai, TOKYO (JP)

(21) Appl. No.: 18/428,069

(22) Filed: Jan. 31, 2024

(51) Int. Cl. G06F 16/9536; G06F 16/9535; G06F 16/9538

(52) U.S. Cl. CPC G06F 16/9536; G06F 16/9535; G06F 16/9538

(57) ABSTRACT

A method, computer system, and a computer program product for automated data enhancement is provided. The present invention may include receiving a draft post from a user device, wherein the draft post includes a user-generated content (UGC). The present invention may also include searching a database to identify at least one resource that is relevant to the UGC. The present invention may further include transforming the draft post to display the UGC and the at least one resource identified in the database, wherein the at least one resource includes evidence supporting the UGC.

### BACKGROUND

The present invention relates generally to the field of computing, and more particularly to data enrichment.

The internet has enabled users to easily create, share, and consume content. For example, users are able to bypass traditional publishers and rely on social networking services (SNS) to publish their content. The published content may then be consumed and shared by other users of the SNS to reach audiences around the world. While expanded access to information has had many positive implications, the ease of publishing content without an obligation to factually verify the content has led to increased dissemination of misinformation and disinformation over the internet.

### SUMMARY

Embodiments of the present invention disclose a method, computer system, and a computer program product for automated data enhancement. The present invention may include receiving a draft post from a user device, wherein the draft post includes a user-generated content (UGC). The present invention may also include searching a database to identify at least one resource that is relevant to the UGC. The present invention may further include transforming the draft post to display the UGC and the at least one resource identified in the database, wherein the at least one resource includes evidence supporting the UGC.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computing environment according to at least one embodiment;

FIG. 2 is a schematic block diagram of a data enhancement environment according to at least one embodiment;

FIG. 3 is a schematic block diagram of a pre-processing functionality according to at least one embodiment;

FIG. 4 is a schematic block diagram of a task-processing functionality according to at least one embodiment;

FIG. 5 is a schematic block diagram of a linked-evidence functionality according to at least one embodiment;

FIG. 6 is an operational flowchart illustrating pre-processing according to at least one embodiment; and

FIG. 7 is an operational flowchart illustrating task-processing according to at least one embodiment.

### DETAILED DESCRIPTION

The following described exemplary embodiments provide a system, method and computer program product for automated enhancement of user-generated content (UGC) with supporting evidence. As such, the present embodiment has the capacity to improve the technical field of data enrichment by automatically recording and indexing new information consumed by a user for future automatic retrieval as potential evidence supporting the user's statements in a UGC. More specifically a data enhancement program may receive a draft post from a user device, where the draft post may include UGC. Then, the data enhancement program may search a database to identify at least one resource that is relevant to the UGC. Thereafter, the data enhancement program may transform the draft post to display the UGC and the at least one resource identified in the database. The at least one resource displayed with the UGC may include evidence supporting the UGC.

As described previously, the internet has enabled users to easily create, share, and consume content. For example, users are able to bypass traditional publishers and rely on social networking services (SNS) to publish their content (e.g., UGC). The published content may then be consumed and shared by other users of the SNS to reach audiences around the world. While expanded access to information has had many positive implications, the ease of publishing content without an obligation to factually verify the content has led to increased dissemination of misinformation and disinformation over the internet.

Even when users want to provide evidentiary resources to support their published content, existing technologies do not provide an efficient way to find the resource among all the information the user has consumed in the past. Further, those who receive the published content without evidentiary support need to determine whether the information in the published content is true.

Therefore, it may be advantageous to, among other things, provide an automated way to detect when a user drafts a post, search for evidence supporting the post from among information the user has seen in the past, and attach the supporting evidence to the post before the post is published over the internet.

According to one embodiment, the data enhancement program may index and save in a database, all of the web pages seen by a user. In one embodiment, indexing the web pages in the database may include morphological parsing, stemming, lemmatization, and other natural language processing (NLP) techniques.

According to one embodiment, when the data enhancement program detects a SNS post drafted by the user, the data enhancement program may perform morphological analysis of the input sentence(s) to extract keywords from the input. In one embodiment, the data enhancement program may query the user's database with the extracted keywords to search for relevant information in the database. In one embodiment, the data enhancement program may propose, as a candidate for evidence, a uniform resource locator (URL) corresponding to the web pages found in the database. Then, the data enhancement program may detect the user's selection of what the user considers to be evidence from the proposed URL(s) and automatically attach the selected URLs to the SNS post. Thereafter, the data enhancement program may interact with the SNS to publish the SNS post with the evidence.

According to one embodiment, the data enhancement program may enable the readers of the SNS posts (e.g., other users of the SNS; those who receive the post) to configure their SNS application and define specific URLs as unreliable or low quality sources of information. Once the unreliable URLs are defined by the user, the data enhancement program may not display any evidence in SNS posts that include the unreliable URLs.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

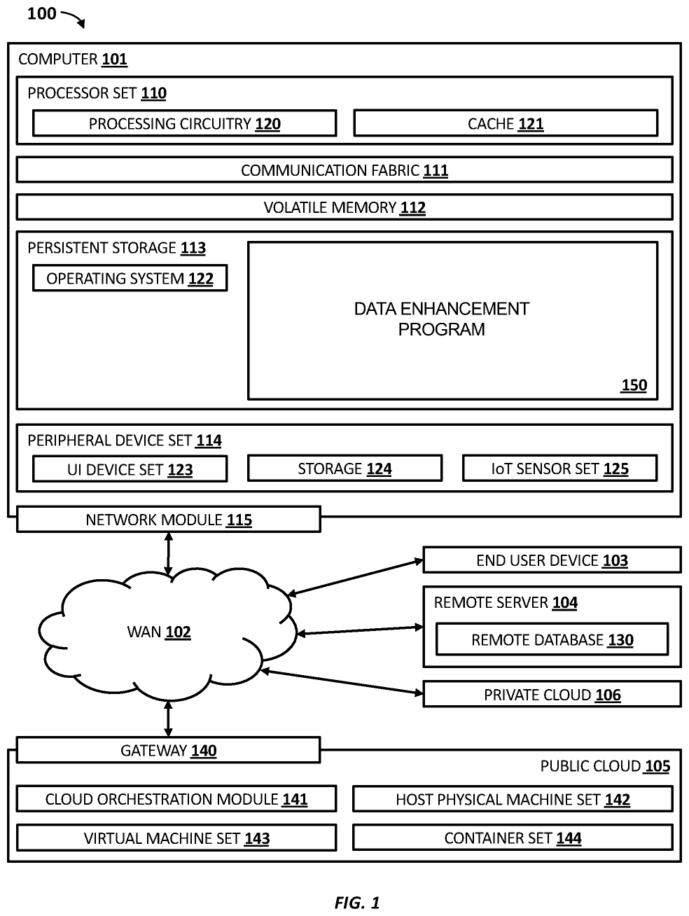

Referring to FIG. 1, a computing environment 100 according to at least one embodiment is depicted. Computing environment 100 contains an example of an environment for the execution of at least some of the computer code involved in performing the inventive methods, such as data enhancement program 150. In addition to data enhancement program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data enhancement program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Furthermore, despite only being depicted in computer 101, data enhancement program 150 may be stored in and/or executed by, individually or in any combination, EUD 103, remote server 104, public cloud 105, and private cloud 106.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The data enhancement program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of Bluetooth SIG, Inc. and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

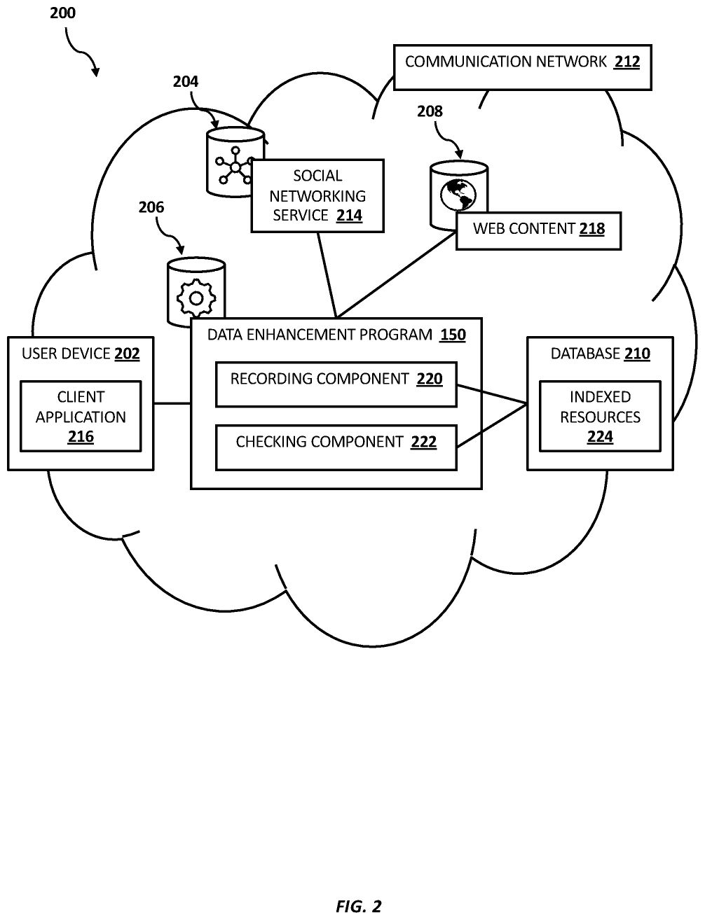

According to the present embodiment, a user using any combination of an EUD 103, remote server 104, public cloud 105, and private cloud 106 may use the data enhancement program 150 to improve the quality of their posts with supporting evidence provided from a database that automatically records and indexes information the user has consumed in the past. Embodiments of the present disclosure are explained in more detail below with respect to FIGS. 2-7.

Referring now to FIG. 2, a schematic block diagram of a data enhancement environment 200 according to at least one embodiment is depicted. Generally, the data enhancement environment 200 may implement the data enhancement program 150 to automatically record and indexing new information consumed by a user for future automatic retrieval as potential evidence supporting the user's statements published over the internet.

The data enhancement environment 200 may include one or more components (e.g., computer 101; end user device (EUD) 103; WAN 102) of the computer environment 100 described above with reference to FIG. 1. As such, the computers (e.g., computer 101) provided in the data enhancement environment 200 may take the form of a desktop computer, laptop computer, tablet computer, smart phone, smart watch or other wearable computer (e.g., head-mounted display), mainframe computer, quantum computer or any other form of computer or mobile device now known or to be developed in the future that is capable of running a program, accessing a network, and/or querying a database.

According to one embodiment, the data enhancement environment 200 may include one or more user devices 202 (also individually referred to as user device 202), a social network server 204, a data enhancement server 206, a web server 208, and one or more databases 210 (also individually referred to as database 210). These and any other electronic devices in data enhancement environment 200 may be communicatively coupled via a communication network 212. The communication network 212 may include various types of wired or wireless communication networks. In one embodiment, the communication network 212 may include the wide area network (WAN) 102 described with reference to FIG. 1. In some embodiments, the WAN may be replaced and/or supplemented by a local area network (LAN), a telecommunication network (e.g., 3G, 4G, 5G), a wireless network, a public switched network and/or a satellite network. In one embodiment, the communication network 212 may enable data to be transferred between devices using short-range wireless technologies, such as, for example, Wi-Fi and/or Bluetooth® (Bluetooth and all Bluetooth-based trademarks and logos are trademarks or registered trademarks of Bluetooth SIG, Inc. and/or its affiliates).

In at least one embodiment, aspects of the data enhancement environment 200 may operate in a cloud computing service model, such as Software as a Service (SaaS), Platform as a Service (PaaS), or Infrastructure as a Service (IaaS). In one embodiment, the data enhancement environment 200 may also be implemented as a cloud computing deployment model, such as a private cloud, community cloud, public cloud, or hybrid cloud.

According to one embodiment, the social network server 204 may include one or more computers that may implement a social networking service (SNS) 214 and/or blogging service. In one embodiment, SNS 214 may enable users of user devices 202 to create, share, and consume user posts published on the SNS 214 platform. In at least one embodiment, “user posts” or “posts” may include user-generated content (UGC) such as, for example, text content, audio content, image content, video content, and/or multimedia content. In one embodiment, the user device 202 may include one or more client applications 216 (individually referred to as client application 216). In at least one embodiment, one of the client applications 216 may include a dedicated social network client application that may enable the user device 202 to perform (e.g., via a user interface) the functions provided by SNS 214 (e.g., posting UGC). In other embodiments, the client application 216 may include a web browser or other application that may enable the user device 202 to implement the SNS 214 (e.g., via SNS web application).

According to one embodiment, the web server 208 may include one or more computers that may communicate with the web browser (e.g., client application 216) to provide web content 218 (e.g., web sites) to the user device 202.

According to one embodiment, the data enhancement server 206 may include one or more computers that may implement the data enhancement program 150. In one embodiment, the data enhancement program 150 (e.g., recording component 220) may automatically detect any resources of information (e.g., web content 218) consumed by the user and record and index those resources in the database 210. In one embodiment, the data enhancement program 150 (e.g., checking component 222) may also detect the user drafting a post for SNS 214 and may automatically recommend one or more of the resources from database 210 that may provide evidence supporting the contents of a user's post for SNS 214. In one embodiment, the data enhancement program may include a single computer program or multiple program modules or sets of instructions being executed by the processors of the computers in data enhancement environment 200 (e.g., user device 202, social network server 204, data enhancement server 206, web server 208). In one embodiment, the data enhancement program 150 may include routines, objects, components, units, logic, data structures, and actions that may perform particular tasks or implement particular abstract data types. In one embodiment, the data enhancement program 150 may be practiced in distributed cloud computing environments where tasks may be performed by local and/or remote processing devices which may be linked through communication network 212. In at least one embodiment, the data enhancement program 150 (e.g., recording component 220 and checking component 222) may be executed on a single computing device (e.g., user device 202).

According to one embodiment, the data enhancement program 150 may be provided as a component of an existing application to extend the functionality of the existing application. For example, the data enhancement program 150 may be provided as a component the client application 216, where the client application 216 may include a web browser or dedicated social network client application, as described above.

According to one embodiment, the data enhancement program 150 may be provided as a web service application running on the data enhancement server 206. In one embodiment, the data enhancement program 150 web service application may communicate and exchange data with the social network server 204, web server 208, and database 210 over the communication network 212 using standard web protocols. In one embodiment, the user may interact with the data enhancement program 150 web service application using a web browser (e.g., client application 216) running on the user device 202. In one embodiment, the user may access both the data enhancement program 150 web service application and the SNS 214 using the web browser (e.g., client application 216).

According to one embodiment, database 210 may take the form of storage 124 and/or remote database 130 as described with reference to FIG. 1. In one embodiment, each user device 202 may include a respective database 210 for storing indexed resources 224 corresponding to resources (e.g., web content 218) consumed by the user. In another embodiment, one database 210 may store corresponding indexed resources 224 for the various user devices 202. In such embodiments, each user device 202 may have access to the corresponding index resources 224 but not to the indexed resources 224 of the other user devices 202.

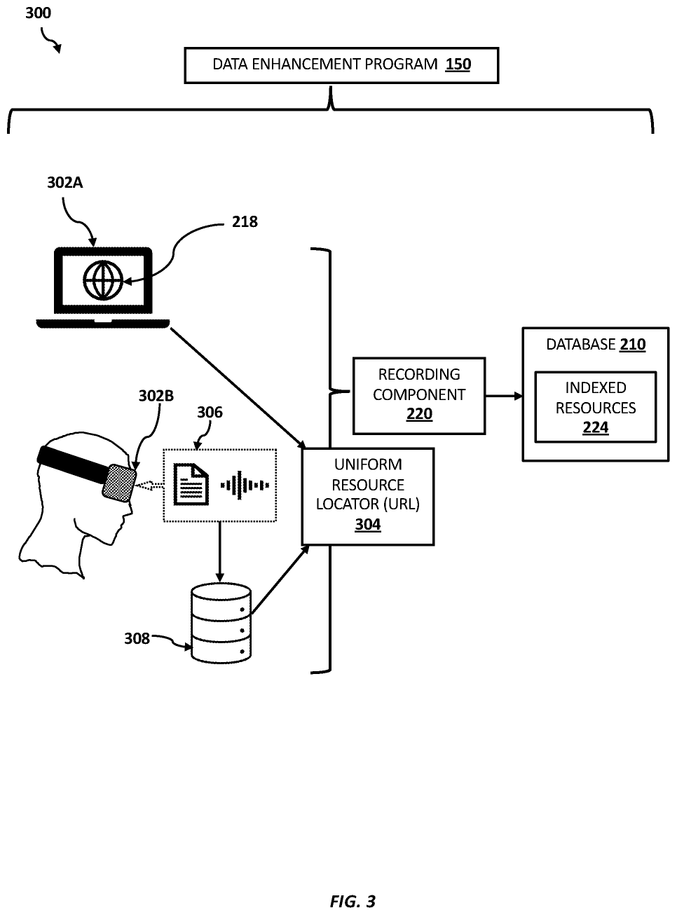

Referring now to FIG. 3, a schematic block diagram of a recording component 220 of the data enhancement program 150 according to at least one embodiment is depicted. FIG. 3 provides a description of recording component 220 with reference to the data enhancement environment 200 (FIG. 2). The functionality of the recording component 220 may be referred to as a pre-processing functionality 300.

According to one embodiment, the data enhancement program 150 may be implemented by a first user device 302A (e.g., laptop). As such, when the first user device 302A accesses a web content 218, the recording component 220 of the data enhancement program 150 may detect that a resource (e.g., web content 218) is being accessed by the user device 302A. In response, the recording component 220 may automatically index the resource (e.g., web content 218) and store the resource and a uniform resource locator (URL) 304 corresponding to the resource in the database 210. In one embodiment, the recording component 220 may generate and store (e.g., in database 210) a searchable index (e.g., indexed resources 224) of all of the resources previously accessed by the user device 302A. In at least one embodiment, indexing the resources may include parsing the contents of the collected resources using natural language processing (NLP) and storing the data in a manner that facilitates fast and accurate informational retrieval. In one embodiment, the indexing may transform the unstructured data found in the collected resources into structured data (e.g., search index) that may be queried using natural language.

According to one embodiment, the data enhancement program 150 may be implemented by a second user device 302B (e.g., head-mounted display (HMD)). In one embodiment, the user may use the second user device 302B to consume various HMD content 306, such as, for example, reading a physical document or listening to audio through an audio component of the HMD. In such embodiments, the recording component 220 may also detect that a resource (e.g., HMD content 306) is being consumed by the user device 302B and proceed to record the HMD content 306 (e.g., capture image of the physical document; record audio). However, because the HMD content 306 does not initially have a corresponding URL 304, the recording component 220 may store the content in a cloud storage device 308 such that the HMD content 306 may be associated with a corresponding URL 304 to the cloud storage. Then, the recording component 220 may automatically index the resource (e.g., HMD content 306) and store the resource and the URL 304 corresponding to the resource in the database 210. In one embodiment, the recording component 220 may be implemented such that only external sources of information in the HMD content 306 is part of the indexed resources 224 in database 210. In other words, content generated by the user (e.g., what the user said/wrote) and captured in the HMD content 306 may not be indexed because such content cannot be used as evidence. In one embodiment, the recording component 220 may exclude the user's content based on technologies such as voice detection (e.g., to detect and exclude user's voice) and motion detection (e.g., to detect and exclude user's writing motion).

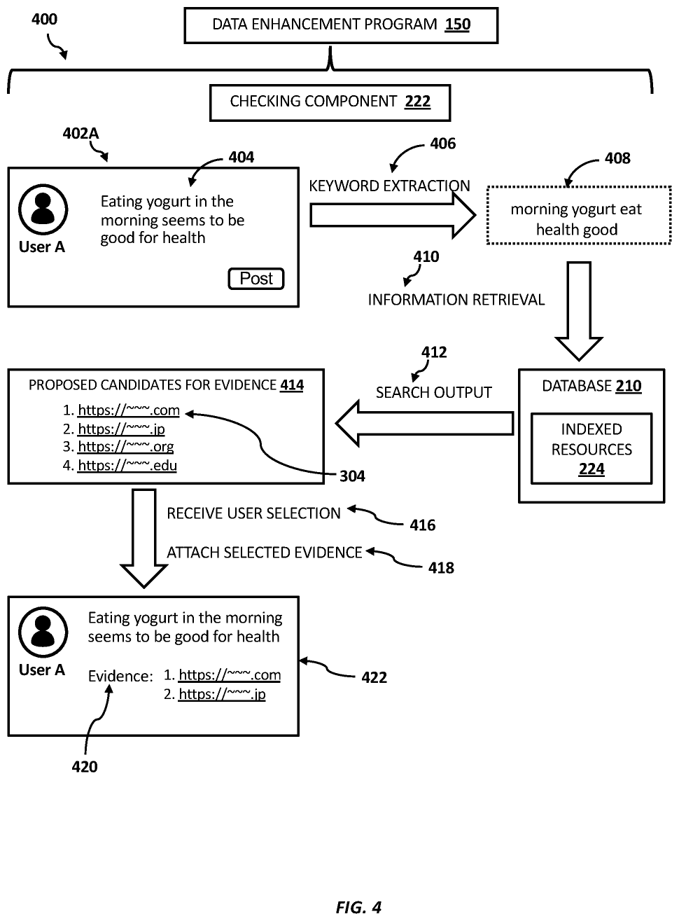

Referring now to FIG. 4, a schematic block diagram of a checking component 222 of the data enhancement program 150 according to at least one embodiment is depicted. FIG. 4 provides a description of recording component 220 with reference to the data enhancement environment 200 (FIG. 2). The functionality of the checking component 222 may be referred to as a task-processing functionality 400.

According to one embodiment, the data enhancement program 150 may be implemented by a user device associated with user A. In one embodiment, the data enhancement program 150 may receive a draft post 402A from user A interacting with the user device (e.g., interacting with social network client application). The draft post 402A may include a social media post, an article, an e-mail, or any other type of post for sharing information (e.g., UGC) over the internet. In one embodiment, the draft post 402A may include text content, audio content, image content, video content, and/or multimedia content. If the data enhancement program 150 determines that the draft post 402A includes natural language content, either in text or audio format, the data enhancement program 150 may implement the checking component 222 to identify resources that provide evidence supporting the natural language statements in the draft post 402A.

In the example illustrated in FIG. 4, user-generated content (UGC) 404 in the draft post 402A is provided in text form. As such, the checking component 222 may directly perform keyword extraction 406 on the UGC 404. In another embodiment, if the UGC 404 was provided in audio form, the data enhancement program 150 may first perform speech-to-text conversion and then perform keyword extraction 406 on the transcribed text.

According to one embodiment, the keyword extraction 406 may include various natural language processing (NLP) techniques such as tokenization and removing unnecessary words (“stop words”) from the tokens (e.g., list of words). The stop words may be determined from a pre-defined dictionary (e.g., removing “a”, “the”, “on”, “in”) and removed from the tokens to result in content words. In some embodiments, the keyword extraction 406 may also include performing morphological analysis, stemming and/or lemmatization to identify the relevant keywords from the input text (e.g., UGC 404). In one embodiment, after keyword extraction 406 is performed, the checking component 222 may generate a query 408 (e.g., search string) to search the database 210. In the example illustrated in FIG. 4, the UGC 404 in the draft post 402A states, “Eating yogurt in the morning seems to be good for health.” The checking component 222 performs the keyword extraction 406 of the statement and generates the query 408, “morning yogurt eat health good.”

According to one embodiment, the checking component 222 uses the query 408 to perform information retrieval 410 from the database 210. The information retrieval 410 may include searching the database 210 to identify and retrieve at least one resource that is relevant to the UGC 404 (e.g., associated with query 408). As described previously, database 210 may store the resources (e.g., web content 218) that have been accessed by user A in the past. These resources, which may include unstructured data (e.g., blog post), may be indexed into structured data to facilitate the information retrieval 410. The checking component 222 may perform a structured data search to query the indexed resources 224 for one or more resources that match or are relevant to the search string (e.g., query 408). In one embodiment, the checking component 222 may parse through the structured data of the indexed resources 224 in a controlled manner to locate the query 408 terms in various fields (e.g., title, author, publication date, content) of the structured data. Thereafter, the checking component 222 may retrieve one or more results from the database 210 and perform a search output 412 of the identified resources that may be relevant to the query 408.

According to one embodiment, the search output 412 may be transmitted to the user device as one or more proposed candidates for evidence 414 (or candidates 414). In one embodiment, each proposed candidate 414 may include the corresponding URL 304 for the resource that was stored in the database 210 by the recording component 220 (e.g., FIG. 3). The candidates 414 may be displayed on the user device as a floating textbox and may include a prompt for the user to select one or more of the candidates 414. In the example illustrated in FIG. 4, the checking component 222 outputs four candidates 414 on the user device of user A and prompts user A to select one or more of the resources as evidence supporting the UGC 404.

Once the user selects what the user considers to be evidence supporting their statement in the draft post 402A, the checking component 222 may receive the user selection 416 and attach the selected evidence 418 to the draft post 402A. In one embodiment, the checking component 222 may transform (e.g., dynamically modify) the draft post 402A to display the UGC 404 with the selected evidence 420. The transformed draft post 402A may be referred to as an enhanced post 422. In one embodiment, the data enhancement program 150 may transmit the enhanced post 422 for publishing on the SNS 214.

According to one embodiment, if the checking component 222 is unable to find a resource that may be considered evidence that supports the user's statement (e.g., UGC 404) in the draft post 402A, the checking component 222 may propose a resource that is otherwise relevant to the user's statement. For example, if the checking component 222 is unable to find a resource supporting “Eating yogurt in the morning seems to be good for health,” but is able to find an alternative resource supporting the health benefits of eating a banana for breakfast, the checking component 222 may output the alternative resource to the user A. In one embodiment, the checking component 222 may predict that the user's statement needs to be corrected based on the alternative resource that was found. As such, in one embodiment, the checking component 222 may propose a correction to the user's statement (e.g., “Did you mean banana?”). In at least one embodiment, the checking component 222 may provide the alternative resource and also propose the correction to the user's statement. In yet another embodiment, if no alternative resource or correction is available, the checking component 222 may notify the user and enable the user to publish the draft post 402A without any supporting evidence.

In the example illustrated in FIG. 4, the draft post 402A includes a factual statement (e.g., UGC 404) and the proposed candidates 414 provide evidence supporting the factual statement. However, in some embodiments, the draft post 402A may include an opinion statement that is based on some factual information (e.g., resource) that the user has seen in the past. In such embodiments, the data enhancement program 150 may also be implemented to provide evidence that supports the user's opinion in the draft post 402A. For example, if the draft post 402A stated “Yogurt is my favorite breakfast,” the checking component 222 may propose candidates 414 (e.g., resources) that indicate the health benefits of eating yogurt for breakfast. As such, the data enhancement program 150 may enable the user to post their opinion with evidence supporting the user's opinion.

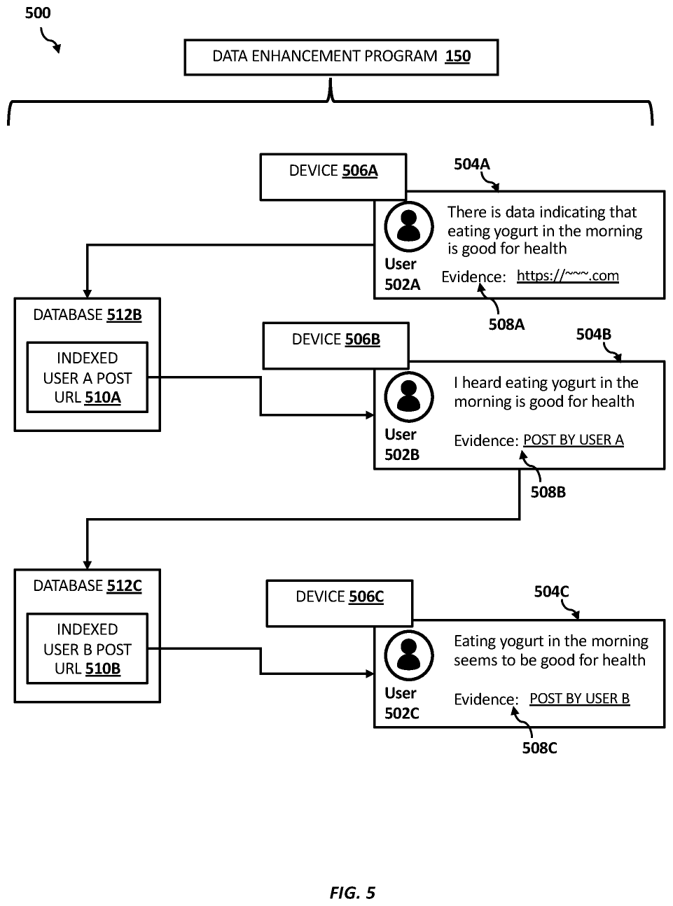

Referring now to FIG. 5, a schematic block diagram of a linked-evidence functionality 500 of the data enhancement program 150 according to at least one embodiment is depicted. FIG. 5 provides a description of the linked-evidence functionality 500 with reference to the data enhancement environment 200 (FIG. 2).

As illustrated in FIG. 5, posts by other users on the SNS 214 may be used as evidence supporting later posts by other users. As such, evidence for the later posts may be found by following the link to the earlier posts. In one embodiment, the linked-evidence functionality 500 may be an automated process similar to the other functionalities of the data enhancement program 150.

According to one embodiment, a first user 502A may publish a first post 504A on the SNS 214 using first user device 506A. The first post 504A may include a first supporting evidence 508A. Then, when a second user 502B views the first post 504A using second user device 506B (e.g., via web browser or SNS client application), the data enhancement program 150 may index and store the first post 504A with a first post URL (e.g., as indexed user A post URL 510A) in a second database 512B associated with the second user device 506B. Then, if the second user 502B drafts a second post 504B that is similar to the first post 504A, the data enhancement program 150 may search the second database 512B and find URL 510A (e.g., link to first post 504A) as evidence supporting the second post 504B. As such, the second user 502B may publish the second post 504B on the SNS 214 with a second supporting evidence 508B that links to first post 504A. In one embodiment, the data enhancement program 150 may transform the URL in the second supporting evidence 508B into a hypertext describing that the evidence 508B links to a post by another user (e.g., post by user A).

Similarly, when a third user 502C views the second post 504B using third user device 506C (e.g., via web browser or SNS client application), the data enhancement program 150 may index and store the second post 504B with a second post URL (e.g., as indexed user B post URL 510B) in a third database 512C associated with the third user device 506C. Then, if the third user 502C drafts a third post 504C that is similar to the second post 504B, the data enhancement program 150 may search the third database 512C and find URL 510B (e.g., link to second post 504B) as evidence supporting the third post 504C. As such, the third user 502C may publish the third post 504C on the SNS 214 with a third supporting evidence 508C that links to second post 504B. In one embodiment, the third supporting evidence 508C may be displayed as a hypertext describing that the evidence 508C links to a post by another user (e.g., post by user B).

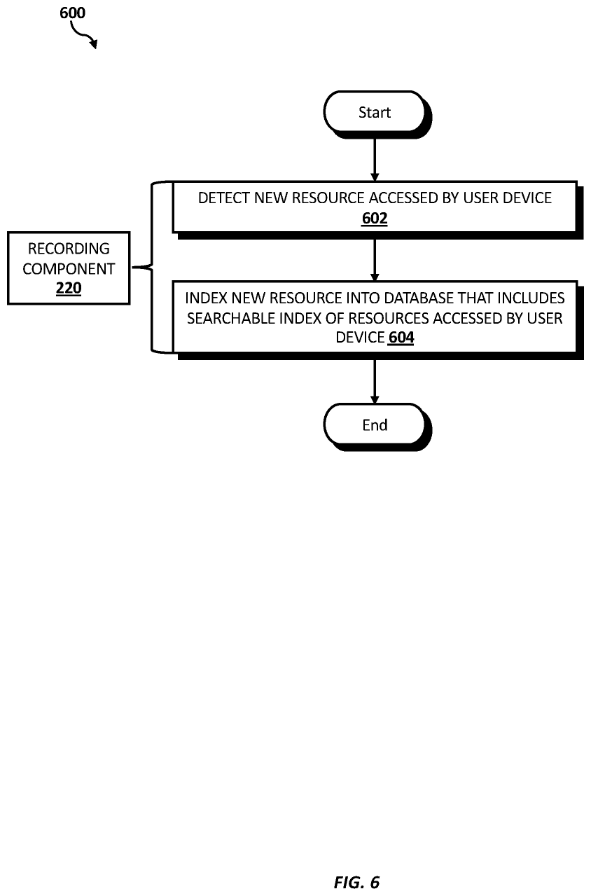

Referring now to FIG. 6, an operational flowchart illustrating an exemplary pre-processing 600 of a data enhancement process used by the data enhancement program 150 according to at least one embodiment is depicted. FIG. 6 provides a description of process 600 with reference to FIGS. 2-5.

According to one embodiment, pre-processing 600 may be executed by the recording component 220 of the data enhancement program 150, as described previously with reference to FIG. 3. One embodiment of pre-processing 600 of the data enhancement process is described below.

At 602, access to a new resource by a user device is detected. According to one embodiment, the data enhancement program 150 may include an opt-in function to enable a user to accept the program's terms of use before activating the program. By opting in, the user may provide the necessary permissions for the data enhancement program 150 to interact with the user device to provide the functionalities of the program. Once the user opts-in, the data enhancement program 150 may monitor the user device to detect when the user accesses or consumes new resources of information. In one embodiment, the data enhancement program 150 may interact with a web browser of the user device to detect when web content is accessed on the user device. In one embodiment, the data enhancement program 150 may determine whether the web content is a new resource based on determining that the web content was not previously stored/indexed in the database associated with the user device.

Thereafter at 604, the new resource is indexed into the database that includes a searchable index of resources accessed by the user device. In response to detecting the new resource accessed by the user device, the data enhancement program 150 may automatically index the resource (e.g., web content) and store the resource and a URL corresponding to the resource in the user's database. The database may store a searchable index of all of the resources accessed by the user device in the past, as described previously with reference to FIG. 3. The data enhancement program 150 may continuously update the searchable index in the database as new resources are consumed by the user.

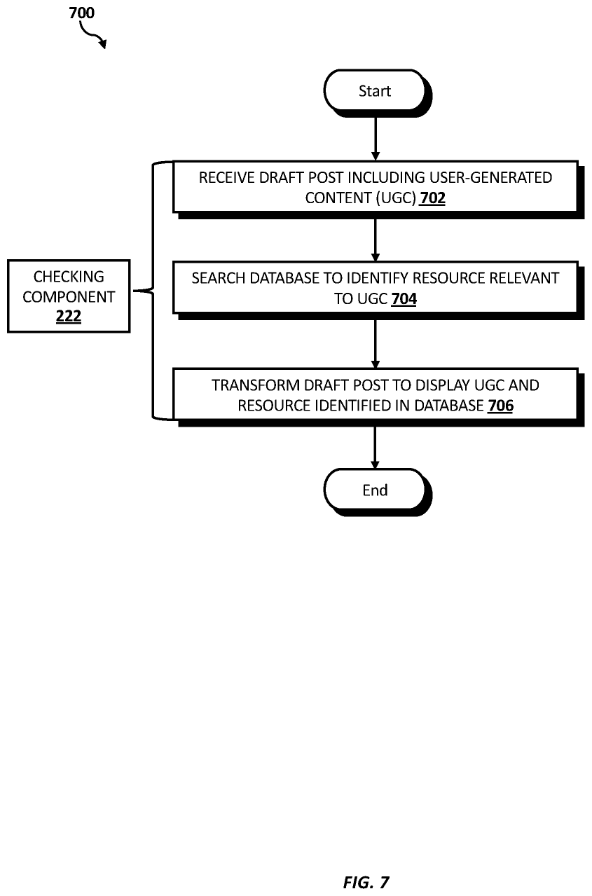

Referring now to FIG. 7, an operational flowchart illustrating an exemplary task-processing 700 of a data enhancement process used by the data enhancement program 150 according to at least one embodiment is depicted. FIG. 7 provides a description of process 700 with reference to FIGS. 2-6.

According to one embodiment, task-processing 700 may be executed by the checking component 222 of the data enhancement program 150, as described previously with reference to FIG. 4. One embodiment of task-processing 700 of the data enhancement process is described below.

At 702, a draft post including user-generated content (UGC) is received. In one embodiment, the data enhancement program 150 may receive a draft post from user interacting with the user device (e.g., interacting with social network client application). The draft post may include a social media post, an article, an e-mail, or any other type of post for sharing information (e.g., UGC) over the internet. In one embodiment, the draft post may include a post that has been created by the user but has not been published (e.g., unpublished post) by the SNS.

At 704, a database is searched to identify at least one resource that is relevant to the UGC. In one embodiment, the data enhancement program 150 may generate a query for searching the database based on one or more natural language processing (NLP) techniques (e.g., morphological analysis), as described previously with reference to FIG. 4. The query may include one or more keywords extracted from the UGC, as described previously with reference to FIG. 4.

Once the query is generated, the data enhancement program 150 may perform a structured data search of the indexed resources in the database. This may include parsing through the indexed resources to locate the query terms in various fields (e.g., title, author, publication date, content) of the structured data. Thereafter, the data enhancement program 150 may retrieve and output one or more results from the database. The search output may be transmitted to the user device as one or more proposed candidates for evidence supporting the UGC in the draft post. In one embodiment, each proposed candidate may include a corresponding URL 304 associated with the resource.

Thereafter at 706, the draft post is transformed to display the UGC and the at least one resource identified in the database. According to one embodiment, the data enhancement program 150 may receive an input from the user device selecting at least one resource as evidence supporting the UGC. Once the user selection is received, the data enhancement program 150 may transform (e.g., dynamically modify) the draft post to display the UGC with the URL of the selected evidence. In one embodiment, the transformed draft post may be referred to as an enhanced post. In one embodiment, the data enhancement program 150 may transmit the enhanced post for publishing on the SNS.

It is contemplated that the data enhancement program 150 may provide several advantages and/or improvements to the technical field of data enrichment. The data enhancement program 150 may also improve the functionality of a computer because the data enhancement program 150 may enable the computer to automatically record and index new information consumed by a user (e.g., via user device) for future automatic retrieval as potential evidence supporting the user's natural language statements in a post for publishing on a SNS. Therefore, it may be advantageous to, among other things, provide an automated way to detect when a user drafts a post, search for evidence supporting the post from among information the user has seen in the past, and attach the supporting evidence to the post before the post is published over the internet.

It may be appreciated that FIGS. 2 to 7 provide only an illustration of one embodiment and do not imply any limitations with regard to how different embodiments may be implemented.

Many modifications to the depicted embodiment(s) may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving a draft post from a user device, wherein the draft post includes a user-generated content (UGC);
searching a database to identify at least one resource that is relevant to the UGC; and
transforming the draft post to display the UGC and the at least one resource identified in the database, wherein the at least one resource includes evidence supporting the UGC.

2. The computer-implemented method of claim 1, further comprising:
generating a query for searching the database, wherein the query includes at least one keyword extracted from the UGC.

3. The computer-implemented method of claim 1, further comprising:
proposing the at least one resource to the user device as a candidate for evidence supporting the UGC; and
receiving an input from the user device indicating a selection of the at least one resource as evidence supporting the UGC.

4. The computer-implemented method of claim 1, further comprising:
detecting a new resource accessed by the user device; and
indexing the new resource into the database, wherein the database includes a searchable index of a plurality of resources accessed by the user device.

5. The computer-implemented method of claim 1, wherein the at least one resource identified in the database includes a Uniform Resource Locator (URL), and wherein transforming the draft post to display the UGC and the at least one resource identified in the database further comprises: inserting the URL of the at least one resource into the draft post with the UGC.

6. The computer-implemented method of claim 1, wherein the UGC includes a factual statement, and wherein the at least one resource includes evidence supporting the factual statement in the UGC.

7. The computer-implemented method of claim 1, wherein the at least one resource identified in the database includes a web content that was previously accessed by the user device.

8. The computer-implemented method of claim 1, wherein the at least one resource identified in the database includes a social media post that was previously accessed by the user device, wherein the social media post is associated with a different user.

9. The computer-implemented method of claim 1, wherein the at least one resource identified in the database includes an image that was captured by a head-mounted display associated with the user device.

10. The computer-implemented method of claim 1, further comprising:
publishing, on a social networking service, the draft post transformed to display the UGC and the at least one resource.

11. The computer-implemented method of claim 1, wherein searching the database to identify the at least one resource that is relevant to the UGC further comprises:
determining that the at least one resource that is relevant to the UGC is not found in the database;
predicting a correction to the UGC based on an alternative resource identified in the database; and
proposing the correction to the UGC.

12. A computer system for automated data enhancement, the computer system comprising:
one or more processors, one or more computer-readable memories and one or more computer-readable storage media;
program instructions, stored on at least one of the one or more storage media for execution by at least one of the one or more processors via at least one of the one or more memories, to receive a draft post from a user device, wherein the draft post includes a user-generated content (UGC);
program instructions, stored on at least one of the one or more storage media for execution by at least one of the one or more processors via at least one of the one or more memories, to search a database to identify at least one resource that is relevant to the UGC; and
program instructions, stored on at least one of the one or more storage media for execution by at least one of the one or more processors via at least one of the one or more memories, to transform the draft post to display the UGC and the at least one resource identified in the database, wherein the at least one resource includes evidence supporting the UGC.

13. The computer system of claim 12, further comprising:
program instructions, stored on at least one of the one or more storage media for execution by at least one of the one or more processors via at least one of the one or more memories, to generate a query for searching the database, wherein the query includes at least one keyword extracted from the UGC.

14. The computer system of claim 12, further comprising:
program instructions, stored on at least one of the one or more storage media for execution by at least one of the one or more processors via at least one of the one or more memories, to propose the at least one resource to the user device as a candidate for evidence supporting the UGC; and
program instructions, stored on at least one of the one or more storage media for execution by at least one of the one or more processors via at least one of the one or more memories, to receive an input from the user device indicating a selection of the at least one resource as evidence supporting the UGC.

15. The computer system of claim 12, further comprising:
program instructions, stored on at least one of the one or more storage media for execution by at least one of the one or more processors via at least one of the one or more memories, to detect a new resource accessed by the user device; and
program instructions, stored on at least one of the one or more storage media for execution by at least one of the one or more processors via at least one of the one or more memories, to index the new resource into the database, wherein the database includes a searchable index of a plurality of resources accessed by the user device.

16. The computer system of claim 12, wherein the at least one resource identified in the database includes a Uniform Resource Locator (URL), and wherein transforming the draft post to display the UGC and the at least one resource identified in the database further comprises:
program instructions, stored on at least one of the one or more storage media for execution by at least one of the one or more processors via at least one of the one or more memories, to insert the URL of the at least one resource into the draft post with the UGC.

17. The computer system of claim 12, wherein the UGC includes a factual statement, and wherein the at least one resource includes evidence supporting the factual statement in the UGC.

18. The computer system of claim 12, wherein the at least one resource identified in the database includes a web content that was previously accessed by the user device.

19. The computer system of claim 12, wherein the at least one resource identified in the database includes a social media post that was previously accessed by the user device, wherein the social media post is associated with a different user.

20. A computer program product for automated data enhancement, the computer program product comprising:
one or more computer-readable storage media;
program instructions, stored on at least one of the one or more storage media, to receive a draft post from a user device, wherein the draft post includes a user-generated content (UGC);
program instructions, stored on at least one of the one or more storage media, to search a database to identify at least one resource that is relevant to the UGC; and
program instructions, stored on at least one of the one or more storage media, to transform the draft post to display the UGC and the at least one resource identified in the database, wherein the at least one resource includes evidence supporting the UGC.
